(19) United States
(12) Patent Application Publication
(10) Pub. No.: US 2011/0154292 A1
(43) Pub. Date: Jun. 23, 2011

(54) STRUCTURE BASED TESTING

(75) Inventors: Kurian John, Bangalore (IN); Kamala Parvathanathan, Bangalore (IN); Snehamoy Karmakar, Bangalore (IN)

(73) Assignee: INTERNATIONAL BUSINESS MACHINES CORPORATION, Armonk, NY (US)

(21) Appl. No.: 12/645,737

(22) Filed: Dec. 23, 2009

(51) Int. Cl. G06F 11/36

(52) U.S. Cl. 717/124

(57) ABSTRACT

A method, a system and a computer program of testing are proposed. An n dimensional structure (n>2) is built using historical data of the n dimensions, wherein the n dimensions correspond to the testing and at least one dimension is a test defect dimension. Intersection points of a plurality of instances of all the n dimensions of the n dimensional structure are populated with test defect values and a representative sub-structure of the n dimensional structure is identified.

### BACKGROUND OF THE INVENTION

1. Field of Invention

Embodiments of the invention disclosed herein relates to testing, and more particularly to regression testing.

2. Background

Conventionally, a number of approaches are available to test software systems, such as, for example, a complete test is run when a new software application (or the first version of a new level thereof involving changes) is developed. In such conventional methods an effort is made to have a satisfactory coverage to ensure that most features of the software application developed are validated. For this purpose, a suite of test cases is typically executed; each test case involves the software application having a predefined input, which returns a corresponding output in response thereto, and a result of the test case is determined by comparing the actual output provided by the software application under test with an expected response thereof.

A regression test may be used for a new version, release or service level of the software application, which typically involves changes to a part thereof. Regression test can be a time consuming process. Typically, in large software applications each run of the regression test involves executing thousands of test cases, sometimes requiring several working days for the test jobs to complete. In some conventional techniques, selective strategies have been deployed for managing regression testing. Some of these selective strategies require augmenting the software application with extra code intended to collect statistics that are then recorded in the profile. Some conventional selective strategies require a thoughtful knowledge of the relationship between the test cases and various components of the software application.

### SUMMARY OF THE INVENTION

Embodiments of the invention are directed to a method, a system and a computer program product for testing. Accordingly, embodiments of the invention are configured to build an n dimensional structure, n>2, using historical data of the n dimensions, where the n dimensions correspond to the testing scenario and at least one of the n dimension is a test defect dimension. Embodiments of the invention further populate intersection points of a plurality of instances of all the n dimensions, with test defect values and identify a representative sub-structure within the n dimensional structure. Other embodiments are also disclosed.

### BRIEF DESCRIPTION OF THE DRAWINGS

Embodiments of the invention are described in detail below, by way of example only, with reference to the following schematic drawings, where:

FIG. 1 shows a schematic of a testing scenario;

FIG. 2A shows a schematic of an exemplary 3-dimensional structure built using historical data, in accordance with an example embodiment of the invention;

FIG. 2B shows a schematic of an exemplary 4-dimensional structure built, in accordance with an example embodiment of the invention;

FIG. 3A shows a high-level schematic illustrating isolating a 2-dimensional sub-structure, in accordance with an example embodiment of the invention;

FIG. 3B shows a high-level schematic illustrating isolated sub-structures and projecting a remainder 3-dimensional structure along a first dimension resulting in a comparison structure, in accordance with another example embodiment of the invention;

FIG. 3C shows a schematic of comparing a comparison structure of FIG. 3B with the isolated sub-structure of FIG. 3A, in accordance with an example embodiment of the invention;

FIG. 3D shows a schematic of computing a score, in accordance with another example embodiment of the invention;

FIG. 3E shows a schematic of an exemplary resultant structure according to an example embodiment of the invention;

FIG. 4A shows a flow chart for identifying a representative sub-structure as disclosed in one embodiment of the invention;

FIG. 4B shows a flow chart for identifying instances of the test case dimension based on the resultant structure of FIG. 3E, as disclosed in one embodiment of the invention; and

FIG. 5 shows a detailed schematic of a computer system used for testing as disclosed in either FIG. 4A or FIG. 4B or both.

### DETAILED DESCRIPTION OF THE INVENTION

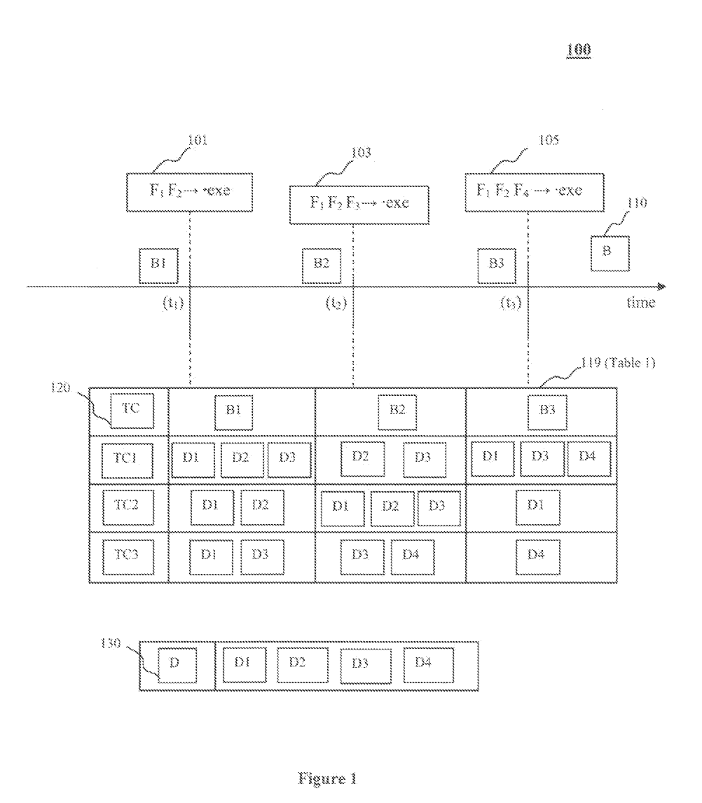

Embodiments of the invention are directed to a method, a system and a computer program product for testing. FIG. 1 shows a schematic 100 of a testing scenario in accordance with an embodiment of the invention. In FIG. 1, element 101, element 103 and element 105 are exemplary set of programs, for example files, resulting into corresponding executables. Element 101 depicts files F1 and F2 being used to develop an executable. Element 103 depicts files F1, F2 and F3 being used to develop another executable. Similarly, element 105 uses files F1, F2 and F4 to develop a corresponding executable. All executables are represented by “.exe” in the corresponding elements. Conventionally, building executables with various files is also termed as a “build”. In this application, a build is represented by the letter B and by a dimension B 110 in FIG. 1 and also in the subsequent description. Thus, as an example, a build B1 is performed at time t1 on time axis in order to build an executable from the element 101, which uses the files F1, F2. As another example, a build B2 is performed at time t2 on time axis to build an executable from the element 103 using the files F1, F2 and F3. As yet another example, a build B3 is performed at time t3 on time axis to build an executable from the element 105 using files F1, F2 and F4.

Each of the builds B1, B2 and B3, which are instances of test build group or test build dimension B 110, may have various test cases associated with it. Typically, various combinations of inputs are tested with same build configuration to verify robustness of a software application. A group or a dimension of these test cases is test case dimension represented as TC 120. As an example, three test cases are defined TC1, TC2 and TC3. TC1, TC2 and TC3 are instances of test case dimension TC 120. When various test case instances are executed against various build instances, typically varying test defects are observed. A group or a dimension of test defect in this description is identified as D 130. In this description, four instances of dimension D 130 are identified as D1, D2, D3 and D4.

Test defects, test builds and test cases can be represented in a Tabular form, indicated in Table 1 (element 119). Table 1 depicts distribution of various instances of test defect dimension D 130 as function of various instances of test case dimension TC 120 and various instances of test build dimension B 110. As an example, for test build B1 for test case TC2, there are two test defects observed, viz., D1 and D2.

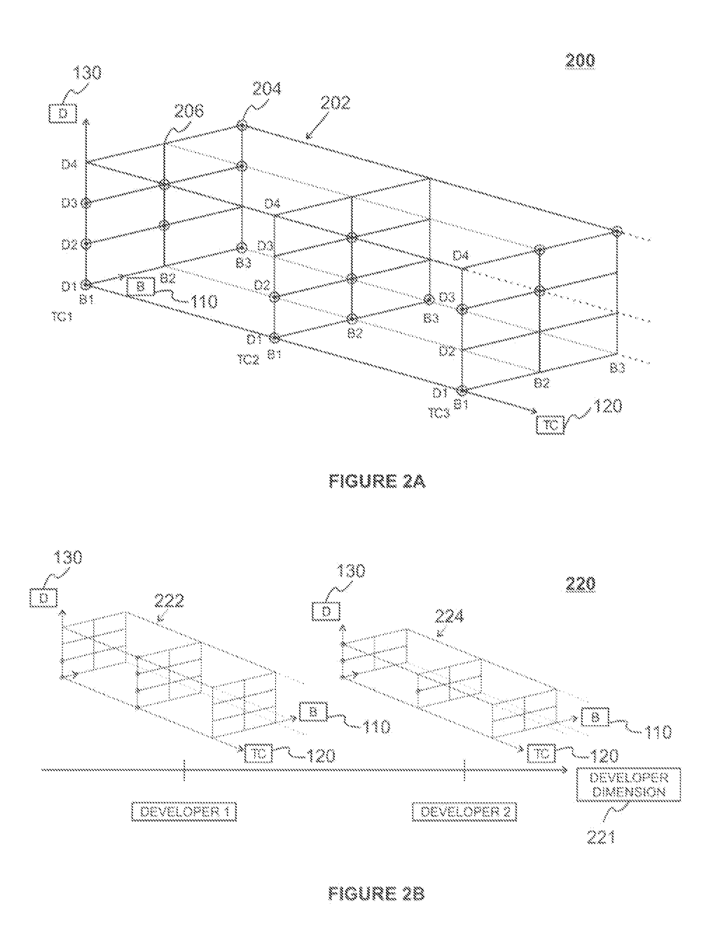

FIG. 2A shows a schematic 200 of an exemplary 3-dimensional structure 202 built using historical data, in an exemplary embodiment using test defect as one dimensions D 130, test build as a second dimension B 110 and test case as a third dimension TC 120, forming a 3-dimensions of rectangular prism structure. In an exemplary mode, test case dimension TC 120 is aligned as conventional X-axis in Cartesian co-ordinate system, and has three instances TC1, TC2 and TC3. Test build dimension B 110 is aligned as conventional Y-axis in Cartesian co-ordinate system and has three instances B1, B2 and B3. Test defect dimension D 130 is aligned as conventional Z-axis in Cartesian co-ordinate system and has four instances D1, D2, D3 and D4. At the intersection points of various instances of the three dimensions of 3-dimensional structure 202, if a test defect is present, it is represented by a circular bead. Thus, as an example, a circular bead 204 represents presence of a test defect at the intersection of TC1, test build instance B3 and test defect instance D4; thereby indicating that test defect D4 is present in test case instance TC1 and test build instance B3. The absence of a circular bead at intersection 206 of test case instance TC1, test build instance B2 and test defect instance D4 indicates the absence of a test defect. 3-dimensional structure 202 is a 3 dimensional representation of Table 1 (element 119). One skilled in the art will understand that the use of circular beads is merely one of many graphical representations that can be used by embodiments of the present invention.

FIG. 2B shows a schematic of an exemplary 4-dimensional structure 220 built, in accordance with an example embodiment of the invention. Four dimensions used to build 4-dimensional structure 220 are a developer dimension 221, test case dimension TC 120, test build dimension B 110, and test defect dimension D 130. In an exemplary mode, there are two instances of developer dimension 221, viz. developer1 and developer2. For each of these two developer dimension instances there is a corresponding rectangular prism structure built using instances of the other three dimensions. Corresponding to developer1 instance there is a rectangular prism structure 222. Corresponding to instance developer2 there is a rectangular prism structure 224 built using other three dimensions. It will be understood by a person ordinarily skilled in the art that multidimensional structures using more than 4 dimensions are also possible.

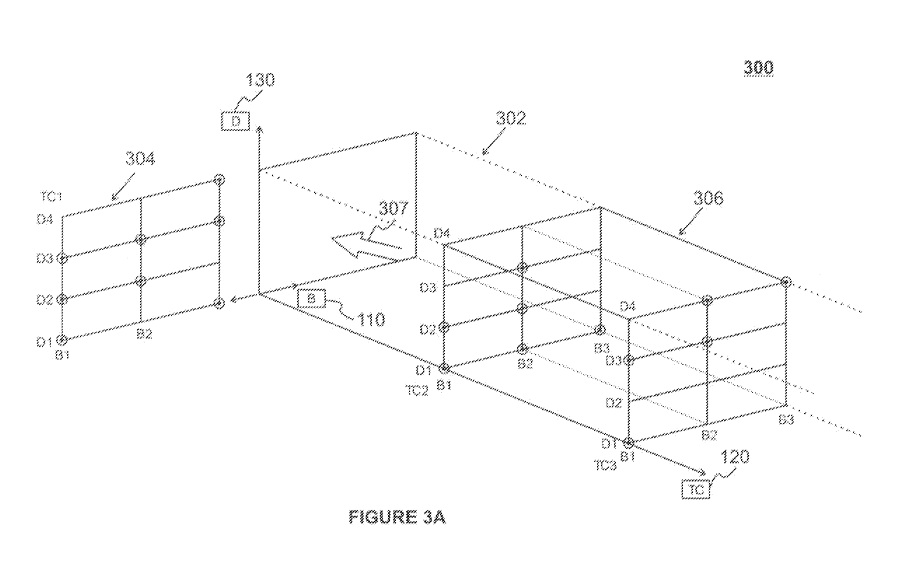

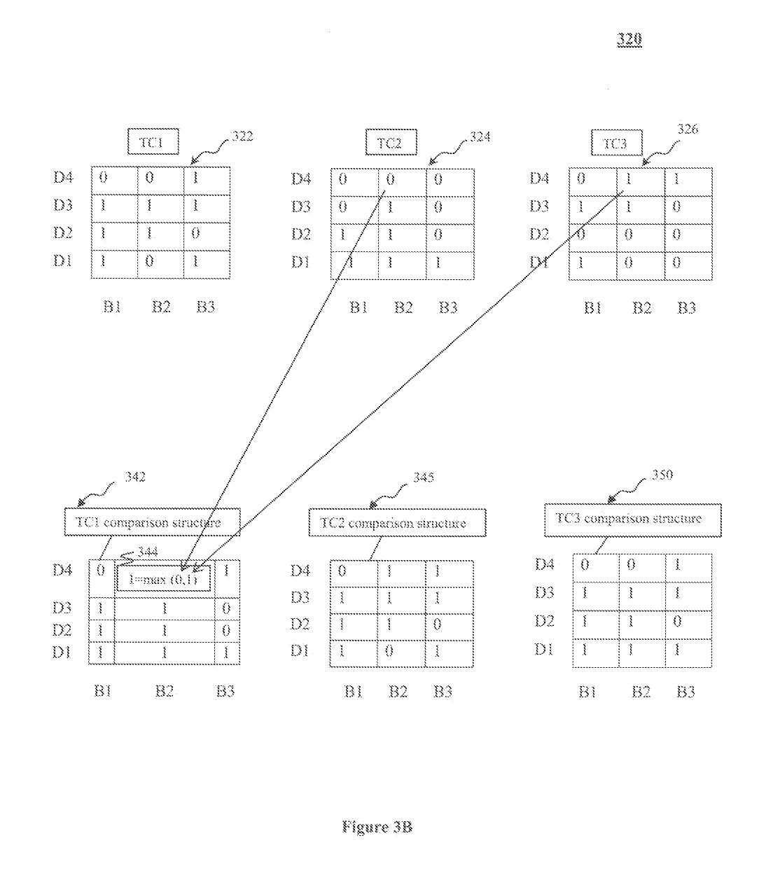

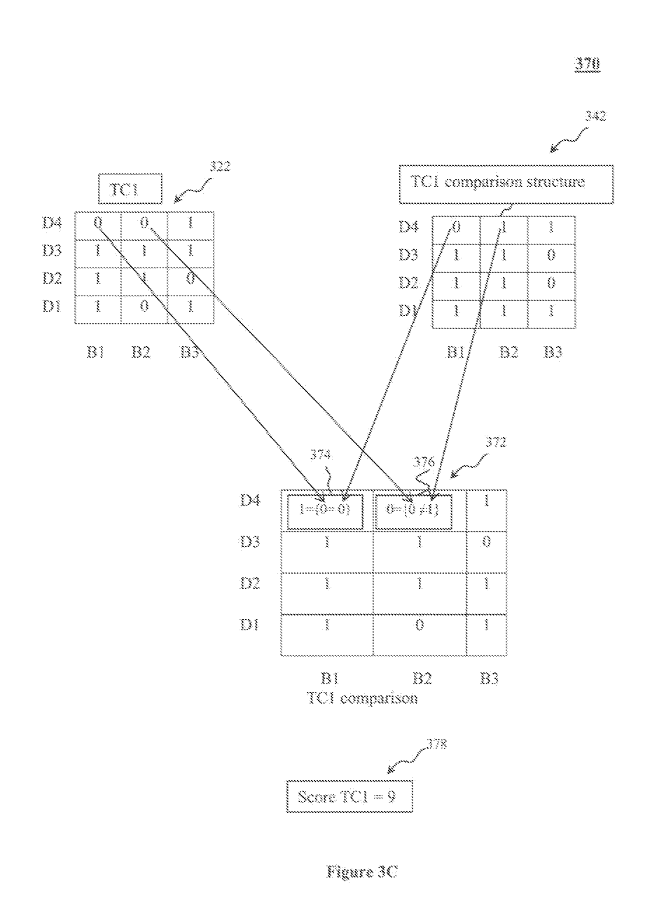

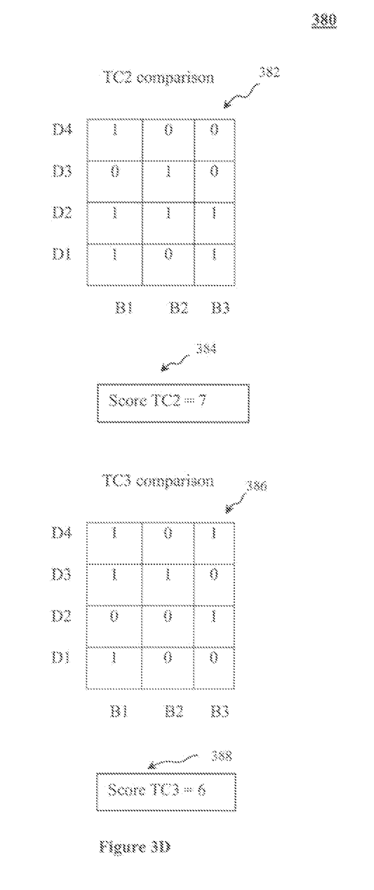

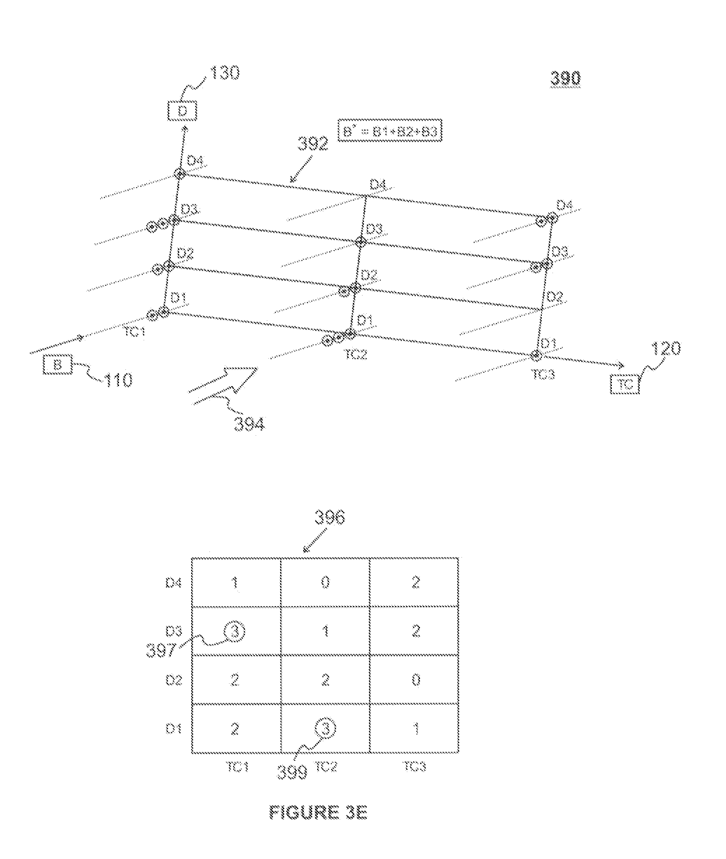

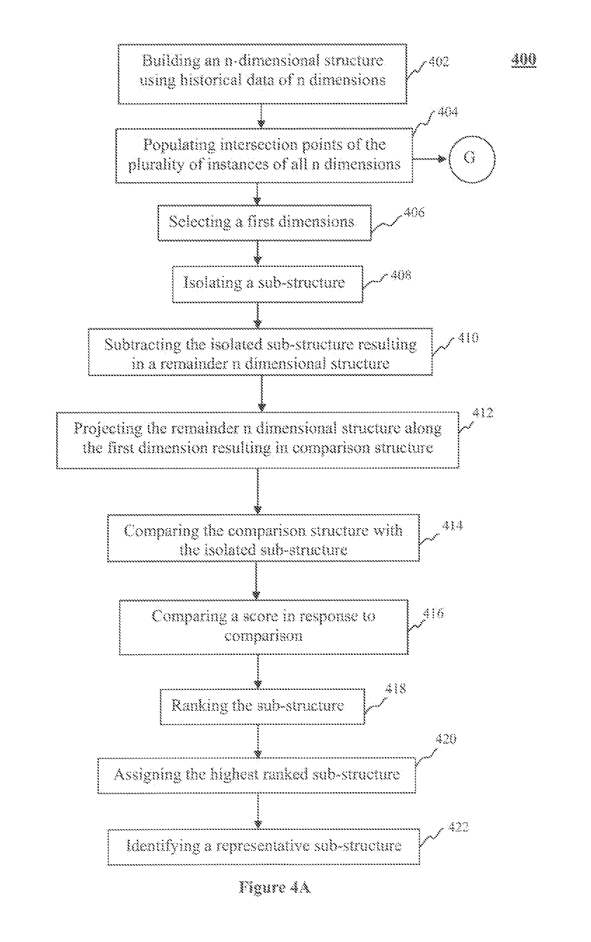

FIG. 3A shows a high-level schematic 300 illustrating isolating a 2-dimensional sub-structure, in accordance with an example embodiment of the invention. Schematic 300 depicts a rectangular prism structure 302 (similar to the rectangular prism structure 202 shown in FIG. 2A) built using three dimensions, viz. a test case dimension TC 120, test build dimension B 110, and test defect dimension D 130. Using rectangular prism structure 302, test case dimension TC 120 is selected as a first dimension. In an iterative mode, each instance of the selected first dimension is isolated. In an exemplary mode, a single instance TC1 is isolated forming a 2-dimensional sub-structure 304. Subtracting isolated 2-dimensional sub-structure 304 results in a remainder 3-dimensional structure 306. Remainder 3-dimensional structure 306 has three dimensions test case TC 120 and has two remaining instances TC2 and TC3. Remainder 3-dimensional structure 306 has three instances B1, B2 and B3 of test build dimension B 110 and has four instances D1, D2, D3 and D4 of test defect dimension D 130, and is projected along the selected first dimension TC 120. The direction of projection is depicted by arrow 307.

FIG. 3B shows a high-level schematic 320 illustrating isolated sub-structures and projecting a remainder 3-dimensional structure along a first dimension, resulting in a comparison structure, in accordance with another example embodiment of the invention. Schematic 320 shows three isolated sub-structures TC1, TC2 and TC3. A matrix 322 represents test defects for an isolated 2-dimensional sub-structure TC1 indicating the presence (represented by “1”) or absence (represented by “0”) of defects, where, rows correspond to four instances D1, D2, D3, and D4 of test defect dimension and three columns correspond to three instances B1, B2 and B3 of test build dimension. Similarly, matrix 324 represents test defects for an isolated 2-dimensional sub-structure TC2 indicating the presence (represented by “1”) or absence (represented by “0”), where rows correspond to four instances D1, D2, D3, and D4 of test defect dimension and three columns correspond to three instances B1, B2 and B3 of test build dimension. Matrix 326 represents test defects for an isolated 2-dimensional sub-structure TC3 indicating the presence (represented by “1”) or absence (represented by “0”), where rows correspond to four instances D1, D2, D3, and D4 of test defect dimension and three columns correspond to three instances B1, B2 and B3 of test build dimension.

For each isolated instance of the selected first dimension TC 120, projection of remainder 3-dimensional structure is performed along the selected first dimension TC 120. As an example, projection for isolated 2-dimensional sub-structure TC1 is shown. Projection, in an exemplary mode, may use a function, for example the “max” function. When 2-dimensional sub-structure TC1 is subtracted the remainder 3-dimensional structure (illustrated as structure 306 in FIG. 3A) has two instances of test case dimension TC 120, viz. TC2 and TC3. Projecting these along the selected first dimension TC 120, combines individual entries at the intersections of multiple instances of the remainder 3-dimensional structure. The projection of the remainder 3-dimensional structure results in a comparison structure. In an exemplary mode, matrix 342 corresponds to TC1 comparison structure, where rows correspond to four instances D1, D2, D3 and D4 of test defect dimension D 130, and columns correspond to three instances B1, B2 and B3 of test build dimension B 110. Entries in cells represent the projected values of presence (1) or absence (0) of test defect based on projection of remainder 3-dimensional structure. In an exemplary mode, “max” function may be used. As an example, an entry for D4 and B2 is computed as 1 based on max function from corresponding cells of TC2 and of TC3. An entry of “1” indicates that in the remainder 3-dimensional structure after subtracting TC1, there is at least one test defect D4 for test build B2 in remaining instances TC2 and TC3. In other exemplary mode, matrix 345 corresponding to TC2 comparison structure is shown. In other exemplary mode, matrix 350 corresponding to TC3 comparison structure is shown.

FIG. 3C shows a schematic 370 of comparing a comparison structure of FIG. 3B with the isolated sub-structure of FIG. 3A, in accordance with an example embodiment of the invention. Schematic 370 shows an exemplary TC1 comparison 372 of isolated 2-dimensional sub-structure TC1 and TC1 comparison structure 342. TC1 comparison 372 shows four rows corresponding to four instances D1, D2, D3 and D4 of test defect dimension D 130. Columns in TC1 comparison 372 correspond to three instances B1, B2 and B3 of test build dimension B. Entries in cells of TC1 comparison 372 are compared values of presence (1) or absence (0) of test defect. As an example cell 374 corresponding to the (D4, B1) shows entry corresponding to intersection of test defect D4 and test build B1, and comparing the corresponding cells in TC1 322 and TC1 Comparison structure 342, it is noticed that both values correspond to “0”. Since these values match, the cell score in TC1 comparison 372 for the cell (D4, B1) is “1”. As another example cell 376 (D4, B2) shows entry corresponding to intersection of test defect D4 and test build B2. Comparing corresponding cell in TC 1 (0) and corresponding cell in TC1 Comparison structure (1), it is noticed that the two are unequal. Since these two do not match, the cell score corresponding to cell 376 (D4, B2) in TC 1 comparison 372 is “0”. Similarly all the cell values for TC1 comparison 372 may be computed in a similar manner. Computing an overall score of this comparison is, in an exemplary mode, preferably done by addition of individual cell entries. In an exemplary mode, score for TC1 322 is calculated as sum of all cell entries of TC1 comparison 372. Thus the score 378 for TC1 is 9.

FIG. 3D shows a schematic 380 of computing a score, in accordance with another example embodiment of the invention. Schematic 380 depicts TC2 comparison 382 and its corresponding score 384. Schematic 380 also depicts TC3 comparison 386 and its corresponding score 388. Similar to the mechanism described in FIG. 3C, all the cell values of TC2 comparison 382 may be computed. Computing an overall score of this comparison is, in an exemplary mode, preferably done by addition of individual cell entries of TC2 comparison 382. In an exemplary mode, score for TC2 is calculated as sum of all cell entries of TC2 comparison 382. Thus the score 384 for TC2 is 7. Similar to the mechanism described in FIG. 3C, all the cell values of TC3 comparison 386 are computed. Computing an overall score of this comparison is, in an exemplary mode, preferably done by addition of individual cell entries of TC3 comparison 386. In an exemplary mode, score for TC3 is calculated as sum of all cell entries of TC3 comparison 386. Thus the score 388 for TC3 is 6. Having computed scores for all three instances TC1, TC2 and TC3 of the selected first dimension TC, these scores are ranked and hence the (high to low) ranked isolated 2-dimensional sub-structures TC1, TC2 and TC3 appear now as TC1→TC2→TC3. Therefore, in an exemplary mode, the representative sub-structure is TC1, since it is the highest ranked.

FIG. 3E shows a schematic 390 of an exemplary resultant structure according to an example embodiment of the invention. FIG. 3, further shows three dimensions test case dimension TC 120, test build dimension B 110 and test defect dimension D 130. FIG. 3 also shows four instances D1, D2, D3 and D4 of test defect dimension D 130; three instances TC1, TC2, TC3 of test case dimension TC 120 and three instances B1, B2 and B3 of test build dimension B 110. FIG. 3 further shows selecting a second dimension. I In an exemplary manner, test build dimension B 110 is selected as the second dimension. Starting from a 3-dimensional structure (for example the structure 202 of FIG. 2A), and using the three dimensions TC 120, B 110 and D 130, populating multiple instances will result in 3-dimensional structure, where projection is performed along the selected second dimension (test build B 110), shown by an arrow 394. This projection includes combining all the test defect values in the 3-dimensional structure along the selected second dimension B 110, resulting in a resultant structure B* 392, where B*=B1+B2+B3. In an exemplary mode, combining may be simply adding. As an example, for test case instance TC1 and for all test builds B1, B2 and B3, total number of test defects instance D3 are three, which is indicated by three circular beads at the intersection of D3 and TC1.

Matrix 396 corresponds to resultant structure 392, which shows four rows corresponding to four instances D1, D2, D3 and D4 of test defect dimension D, and the columns correspond to three instances TC1, TC2 and TC3 of test case dimension TC. Entries in cells of are added values of presence (1) or absence (0) of test defect. As an example cell 397 (D3, TC1) shows an entry “3” corresponding to intersection of test defect D3 and test case TC1. As another example cell 399 (D1, TC2) shows an entry “3” corresponding to intersection of test defect D1 and test case TC2. These high value cells may be of interest to a user trying to isolate more frequent defects to improvise on the regression testing.

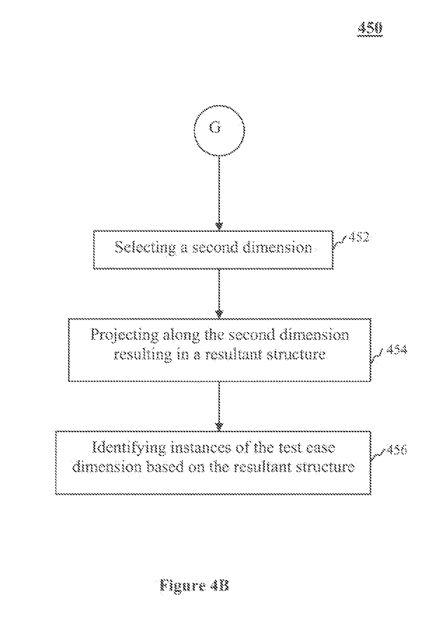

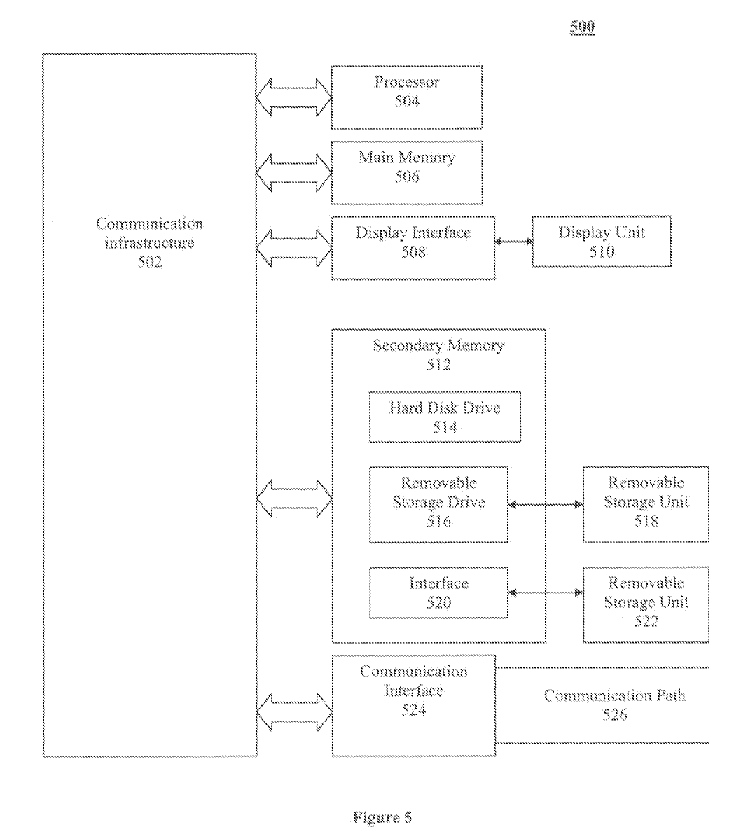

FIG. 4A shows a flow chart of a method 400 for identifying a representative sub-structure as disclosed in one embodiment of the invention. Step 402 depicts building an n dimensional structure (n>2) using historical data of the n dimensions, wherein the n dimensions correspond to testing and at least one dimension is a test defect dimension. Preferably, the testing may be a regression testing. In an exemplary mode, n=3, i.e. the structure may be a 3-dimensional structure. The three dimensional structure has, apart from the test defect dimension, a test case dimension and a test build dimension. Each of the n dimensions has a plurality of instances.

Step 404 depicts populating intersection points of the plurality of the instances of all the n dimensions with test defect values. In one embodiment, the test defect values are either 0 or 1. It should be obvious to one skilled in the art that the test defect values may also be calculated for example using a set of pre-defined weights or other well know techniques. Step 406 depicts selecting a first dimension from the n dimensions. For each instance of the first dimension steps 408 to step 416 are iteratively performed.

Step 408 depicts isolating a sub-structure having (n−1) dimensions from the n dimensional structure, wherein the sub-structure includes all the test defect values in the n dimensional structure corresponding to intersection of the instance of the first dimension and the remaining (n−1) dimensions. Step 410 shows subtracting the isolated sub-structure from the n dimensional structure resulting in a remainder n dimensional structure. Step 412 depicts projecting the remainder n dimensional structure along the first dimension resulting in a comparison structure having (n−1) dimensions. In one embodiment, projecting may use a “max” function.

Step 414 depicts comparing the comparison structure with the isolated sub-structure. Step 416 depicts computing a score in response to the comparison. For example, in one embodiment the step of computing may use a distance metric. As discussed above, after step 416, the step 408 through step 416 are performed iteratively for each instance of the first dimension. Step 418 depicts ranking all the sub-structures for all the instances of the first dimension. Step 420 shows assigning the highest ranked sub-structure as the representative sub-structure. Step 422 depicts identifying a representative sub-structure of the n dimensional structure.

FIG. 4B shows a flow chart of a method 450 for identifying instances of the test case dimension based on the resultant structure of FIG. 3E, as disclosed in one embodiment of the invention. Having built an n dimensional structure using historical data of n dimensions and having populated intersection points of the plurality of instances of all n dimensions using step 402 and step 404 of FIG. 4A, step 452 depicts selecting a second dimension other than the test case dimension. Step 454 depicts projecting along the second dimension, for all instances of the second dimension, resulting in a resultant structure, wherein projecting includes combining all the test defect values in the n-dimensional structure, along the second dimension, corresponding to intersection of the instance of the second dimension and the remaining (n−1) dimensions. Step 456 depicts identifying instances of the test case dimension based on the resultant structure.

FIG. 5 shows a detailed schematic of a computer system used for testing. FIG. 5 is a block diagram of an exemplary computer system 500 that can be used for implementing various embodiments of the present invention. In some embodiments, the computer system 500 can be used as a system executing schematics of any one of FIG. 2A, FIG. 2B, FIG. 3A through FIG. 3E or a combination thereof. The computer system 500 can also be used to perform the steps described in either FIG. 4A or FIG. 4B or both. The Computer system 500 includes a processor 504. It should be understood although FIG. 5 illustrates a single processor, one skilled in the art would appreciate that more than one processor can be included as needed. The processor 504 is connected to a communication infrastructure 502 (for example, a communications bus, cross-over bar, or network) where the communication infrastructure 504 is configured to facilitate communication between various elements of the exemplary computer system 500. Various software embodiments are described in terms of this exemplary computer system. After reading this description, it will become apparent to a person of ordinary skill in the relevant art(s) how to implement the invention using other computer systems and/or computer architectures.

Exemplary computer system 500 can include a display interface 508 configured to forward graphics, text, and other data from the communication infrastructure 502 (or from a frame buffer not shown) for display on a display unit 510. The computer system 500 also includes a main memory 506, which can be random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. The removable storage unit 518, represents, for example, a floppy disk, magnetic tape, optical disk, etc. which is read by and written to by the removable storage drive 516. As will be appreciated, the removable storage unit 518 includes a computer usable storage medium having stored therein computer software and/or data.

In exemplary embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system 500.

The computer system 500 may also include a communications interface 524. The communications interface 524 allows software and data to be transferred between the computer system and external devices. Examples of the communications interface 524 may include a modem, a network interface (such as an Ethernet card), a communications port, a PCMCIA slot and card, etc. Software and data transferred via the communications interface 524 are in the form of signals which may be, for example, electronic, electromagnetic, optical, or other signals capable of being received by communications interface 524. These signals are provided to the communications interface 524 via a communications path (that is, channel) 526. The channel 526 carries signals and may be implemented using wire or cable, fiber optics, a phone line, a cellular phone link, an RF link, and/or other communications channels.

In this description, the terms “computer program medium,” “computer usable medium,” and “computer readable medium” are used to generally refer to media such as the main memory 506 and the secondary memory 512, the removable storage drive 516, a hard disk installed in the hard disk drive 514, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface, including a wired network or a wireless network, that allows a computer to read such computer readable information.

Computer programs (also referred to herein as computer control logic) are stored in the main memory 506 and/or the secondary memory 512. Computer programs may also be received via the communications interface 524. Such computer programs, when executed, can enable the computer system to perform the features of exemplary embodiments of the present invention as discussed herein. In particular, the computer programs, when executed, enable the processor 504 to perform the features of the computer system 500. Accordingly, such computer programs represent controllers of the computer system.

Embodiments of the invention further provide a computer program product for testing, the computer program product including a computer readable storage medium having a computer readable program code embodied therewith as described in the various embodiments set forth above and described in detail. Embodiments of the invention further provide a system of testing, wherein the system includes at least one processor and at least one memory.

Advantages of various embodiments of the invention include faster identification of important instances of various dimensions of regression testing. Advantages of various embodiments of the invention also include ease of use, development of potentially wider representative and useful coverage of test cases.

The described techniques may be implemented as a method, apparatus or article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Although exemplary embodiments of the invention have been described in detail, it should be understood that various changes, substitutions and alternations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the invention.

What is claimed is:

1. A method for testing, the method comprising:
building an n dimensional structure (n>2) using historical data of the n dimensions, wherein at least one dimension is a test defect dimension.

2. The method of claim 1, wherein the n dimensional structure is a three dimensional structure.

3. The method of claim 2, wherein the three dimensional structure comprises at least a test case dimension and a test build dimension.

4. The method of claim 1, wherein each of the n dimensions includes a plurality of instances.

5. The method of claim 4, further comprises:
populating intersection points of the plurality of the instances of all the n dimensions with test defect values.

6. The method of claim 5, wherein the test defect values are either 0 or 1.

7. The method of claim 5, wherein the test defect values are calculated using a set of pre-defined weights.

8. The method of claim 6, further comprising:
identifying a representative sub-structure of the n dimensional structure.

9. The method of claim 8, further comprising:
selecting a first dimension from the n dimensions;
for each instance of the first dimension, iteratively:
isolating a sub-structure having (n−1) dimensions from the n dimensional structure, wherein the sub-structure includes all the test defect values in the n dimensional structure corresponding to intersection of the instance of the first dimension and the remaining (n−1) dimensions;
subtracting the isolated sub-structure from the n dimensional structure resulting in a remainder n dimensional structure;
projecting the remainder n dimensional structure along the first dimension resulting in a comparison structure having (n−1) dimensions;
comparing the comparison structure with the isolated sub-structure; and
computing a score;
ranking all the sub-structures for all the instances of the first dimension; and
assigning the highest ranked sub-structure as the representative sub-structure.

10. The method of claim 10, wherein projecting the remainder n dimensional structure along the first dimension resulting in a comparison structure having (n−1) dimensions uses a max function.

11. The method of claims 10, wherein the step of computing the score uses a distance metric.

12. The method of claim 5, further comprising:
selecting a second dimension other than the test case dimension;
projecting along the second dimension, for all instances of the second dimension, resulting in a resultant structure, including combining all the test defect values in the n-dimensional structure, along the second dimension, corresponding to intersection of the instance of the second dimension and the remaining (n−1) dimensions; and
identifying instances of the test case dimension based on the resultant structure.

13. A system for testing, the system comprising at least one processor and at least one memory, wherein the processor is adapted to:
build an n dimensional structure (n>2) using historical data of the n dimensions, wherein at least one dimension is a test defect dimension.

14. The system of claim 13, wherein the n dimensional structure is a three dimensional structure, wherein the three dimensions comprise at least a test build dimension and a test case dimension, and wherein each of the three dimensions has a plurality of instances.

15. The system of claim 13, wherein the processor is further adapted to:
populate intersection points of a plurality of the instances of all the n dimensions, with test defect values.

16. The system of claim 15, wherein the test defect values are calculated using a set of pre-defined weights.

17. The system of claim 15, wherein the processor is further adapted to:
identify a representative sub-structure of the n dimensional structure;
select a first dimension from the n dimensions;
for each instance of the first dimension, iteratively:
isolate a sub-structure having (n−1) dimensions from the n dimensional structure, wherein the sub-structure includes all the test defect values in the n dimensional structure corresponding to intersection of the instance of the first dimension and the remaining (n−1) dimensions;
subtract the isolated sub-structure from the n dimensional structure resulting in a remainder n dimensional structure;
project the remainder n dimensional structure along the first dimension resulting in a comparison structure having (n−1) dimensions;
compare the comparison structure with the isolated sub-structure; and
compute a score;
rank all the sub-structures for all the instances of the first dimension; and
assign the highest ranked sub-structure as the representative sub-structure.

18. A computer program product for testing, the computer program product comprising:
a computer readable storage medium having a computer readable program code embodied therewith, the computer readable program code configured to:
build an n dimensional structure (n>2) using historical data of the n dimensions, wherein at least one dimension is a test defect dimension, wherein each of the n dimensions has a plurality of instances; and
populate intersection points of the plurality of the instances of all the n dimensions, with test defect values.

19. The computer program product of claim 18, wherein the computer readable program code is further configured to:
identify a representative sub-structure of the n dimensional structure.
select a first dimension from the n dimensions;
for each instance of the first dimension, iteratively:
isolate a sub-structure having (n−1) dimensions from the n dimensional structure, wherein the sub-structure includes all the test defect values in the n dimensional structure corresponding to intersection of the instance of the first dimension and the remaining (n−1) dimensions;
subtract the isolated sub-structure from the n dimensional structure resulting in a remainder n dimensional structure;
project the remainder n dimensional structure along the first dimension resulting in a comparison structure having (n−1) dimensions;
compare the comparison structure with the isolated sub-structure; and
compute a score;
rank all the sub-structures for all the instances of the first dimension; and
assign the highest ranked sub-structure as the representative sub-structure.

20. The computer program product of claim 18, wherein the computer readable program code is further configured to:
select a second dimension other than the test case dimension;
project along the second dimension, for all instances of the second dimension, resulting in a resultant structure, including combining all the test defect values in the n-dimensional structure, along the second dimension, corresponding to intersection of the instance of the second dimension and the remaining (n−1) dimensions; and
identify instances of the test case dimension based on the resultant structure.
